(19) United States
(12) Patent Application Publication
(10) Pub. No.: US 2004/0213333 A1
(43) Pub. Date: Oct. 28, 2004

(54) Sigma-delta modulation code division multiple-access receiver

(76) Inventors: Kaibin Huang, Pandan Gardens (SG); Kwee Tong Heng, The Tropica (SG); Po Shin Francois Chin, Serangoon Central (SG)

Correspondence Address: CONLEY ROSE, P.C., P. O. BOX 3267, HOUSTON, TX, 77253-3267, US

(21) Appl. No.: 10/478,938

(22) PCT Filed: May 25, 2001
(86) PCT No.: PCT/SG01/00103

(51) Int. Cl. H04B 1/707

(52) U.S. Cl. 375/150

(57) ABSTRACT

A code division multiple-access receiver comprises an analog-to-digital converter for digitising a demodulated spread signal. The analog-to-digital converter is a Sigma-Delta modulator. The receiver also comprises a despreader comprising simple logic gates and an integrator, performing the function of despreading the digitised demodulated spread signal into a digitised baseband signal. The despreader doubles as a Sigma-Delta demodulator and hence eliminates a separate stage of Sigma-Delta demodulation.

### FIELD OF INVENTION

The invention relates generally to communication receivers and in particular to communication receivers using code division multiple-access (CDMA) and Sigma-Delta modulation techniques.

### BACKGROUND

The Sigma-Delta modulation technique is popularly used ill analog-to-digital conversion (ADC) to provide high-resolution for narrow-band signals such as audio signals. Using a sufficiently high over-sampling ratio, where the over-sampling ratio is defined as the ratio between half the sampling frequency and the signal bandwidth, a Sigma-Delta ADC is able to afford high digitisation resolution; a result that is too costly and difficult to achieve using other types of ADC. Recent advances in Sigma-Delta ADC technology have enabled the digitisation of signals with low power-consumption and high resolution. A. Namdar, and B. H. Leung, “A 40-M, 12-bit, 18-mW, IF Digitizer with Mixer inside a sigma-Delta Modulator Loop”, IEEE Journal of Solid-State Circuits, vol 34-12, pp 1765-1776, Dec. 1999 describes an example of a Sigma-Delta ADC with 400 MHz IF, 12-bit sampling resolution at a 40 kHz bandwidth and dissipates 18 mW of power. However, because its resolution depends on the over-sampling ratio, the Sigma-Delta ADC is rarely used to digitise wide-band signals as such an ADC may result in unrealistically high sampling frequencies.

A Sigma-Delta ADC cascades a Sigma-Delta modulator and a demodulator. Noise shaping is performed by the modulator. The power spectrum of quantisation noise in relation to the Sigma-Delta modulator is shaped in such a way that the noise power in the wanted-signals frequency band, in this instance the base-band, is minimised, thereby improving the signal-to-noise ratio (SNR) of the Sigma-Delta ADC.

FIG. 1 is a spectral diagram that compares the power spectrums of quantisation noise in relation to the Sigma-Delta modulation 102 and a pulse-code modulation (PCM) ADC 104. The in-band signals in abase-band 106 (f<f_{b}) can be recovered with high resolution using the Sigma-Delta demodulator, which removes out-of-band quantisation noise by applying low-pass filtering. As FIG. 1 illustrates, the Noise Spectrum of PCM ADC 104 is constant across the bandwidth fₛ/2 and greater than the Noise Spectrum of Sigma-Delta ADC 102 within the frequency band f_{b} of the inband signal 106.

FIG. 2 is a block diagram of a first-order Sigma-Delta ADC, which consists of a first-order 1-bit Sigma-Delta modulator and a demodulator, in this case, a decimator. The first-order Sigma-Delta Modulator includes a discrete integrator 210, a 1-bit quantizer 214 and a 1-bit digital-to-analog converter (DAC) 218 in a feedback loop 202. The digital decimator 216 includes a lowpass filter 220 in series with a subsequent downsampler module or decimator 222. In particular, the Sigma-Delta modulator comprises an adder 224, which has an input sequence x[n] and a feedback input (negative) from the 1-bit DAC 218. The output of the adder 224 is input to the discrete integrator 210. The discrete integrator 210 comprises an adder 226 and a delay element (Z⁻¹) 228 in series. The output 212 of the delay 228 is provided via a feedback path 210A to the adder 226 and to the 1-bit quantizer 214. The quantizer 214 produces output stream y[n] 204: the output stream y[n] 204 of the Sigma-Delta modulator is provided as input to the digital decimator and fed back via the feedback loop 202 containing 1-bit DAC 218 to the first adder 224.

A linear model is used for modelling the modulator for the purpose of analysis. In this linear model, the feedback loop 202 forces the average value of the quantised 1-bit output stream at very high-rate 204 to track the narrow-band input analog signal x[n] 206. Any persistent difference 208 between the input and output signals 206, 204 accumulates in the integrator 210, which performs a self-correction function. The 1-bit output signal y[n] 204 is fed to the digital decimator 216 for demodulation

The system transfer function of the single-bit Sigma-Delta modulator is:

Y(z)=z⁻¹·X(z)+(1−z⁻¹)·E(z), (1)

where Y(z), X(z) and E(z) are z-transforms of the output signal y[n], the input signal x[n] and quantisation noise e[n] from the quantizer 214, respectively. The signal transfer function (STF) and noise transfer function (NTF) of the single-bit Sigma-Delta ADC are hence:

STF=z⁻¹, and

NTF=(1−z⁻¹). (2)

As the noise transfer function is a high-pass filter function, quantisation noise is shaped by the single-bit Sigma-Delta ADC such that the in-band noise is minimized, as shown in FIG. 1, while a large amount of high-frequency noise is allowed to pass-through. In the subsequent stage of the digital decimator or demodulator 216, the low-pass filter 220 attenuates out-of-band noise power at high frequencies and the filtered, over-sampled single-bit quantised signal output 221 is decimated to a Nyquist rate multi-bit output by the downsampler 222.

A higher-order Sigma-Delta ADC, e.g. a second order Sigma-Delta ADC, maybe used instead to provide more noise-shaping effect and hence provide better digitisation resolution.

However, the foregoing Sigma-Delta ADC discussed above is disadvantageous in that such an ADC is applicable only to narrow-band signals. Thus, a need clearly exists for a Sigma-Delta ADC for digitising wide-band signals with high-resolution and in particular wideband CDMA signals.

Summary

In accordance with a first broad aspect of the invention, a code division multiple-access receiver is disclosed. The receiver comprises a Sigma-Delta modulator for digitising and modulating a wide-band received signal. The receiver also comprises a despreader for despreading and demodulating the Sigma-Delta modulated wide-band signal into a narrow-band signal with high-resolution.

In accordance with a second broad aspect of the invention, a method for performing code division multiple-access reception is disclosed. The method comprises the steps of digitising and modulating a wide-band received signal with a Sigma-Delta modulator. The method also comprises the steps of despreading and demodulating the Sigma-Delta modulated wide-band signal into a narrow-band base-band signal.

### BRIEF DESCRIPTION OF DRAWINGS

Embodiments of the inventions are described hereinafter with reference to the following drawings, in which:

FIG. 1 is a spectral diagram comparing noise spectrums of a Sigma-Delta ADC and a PCM ADC;

FIG. 2 is a block diagram of a first-order Sigma-Delta ADC;

FIGS. 3A and 3B are block diagrams of a baseband SD-CDMA receiver according to an embodiment of the invention;

FIGS. 4A and 4B are power spectral diagrams for analysing the despreading process relating to the SD-CDMA receiver illustrated in FIGS. 3A and 3B;

FIG. 5 is a block diagram of a conventional CDMA receiver;

FIG. 6 is a chart illustrating results of simulations of the baseband SD-CDMA receiver of FIG. 3A and the conventional CDMA receiver of FIG. 5 in an Additive White Gaussian Noise (AWGN) channel;

FIG. 7 is a chart illustrating results of simulations of the baseband SD-CDMA receiver of FIG. 3A and the conventional CDMA receiver of FIG. 5 in multi-path and AWGN channel;

FIG. 8 is a block diagram of a RAKE receiver, to which the baseband SD-CDMA receiver of FIGS. 3A and 3B is applied;

FIGS. 9A and 9B are block diagrams of a bandpass SD-CDMA Receiver in accordance with another embodiment of the invention;

FIG. 10 is a block diagram of a RAKE receiver, to which the baseband SD-CDMA receiver of FIGS. 9A and 9B is applied; and

FIG. 11 is a Power Spectrum of a dual-mode W-GDMA/GSM receiver station according to a father application of the invention.

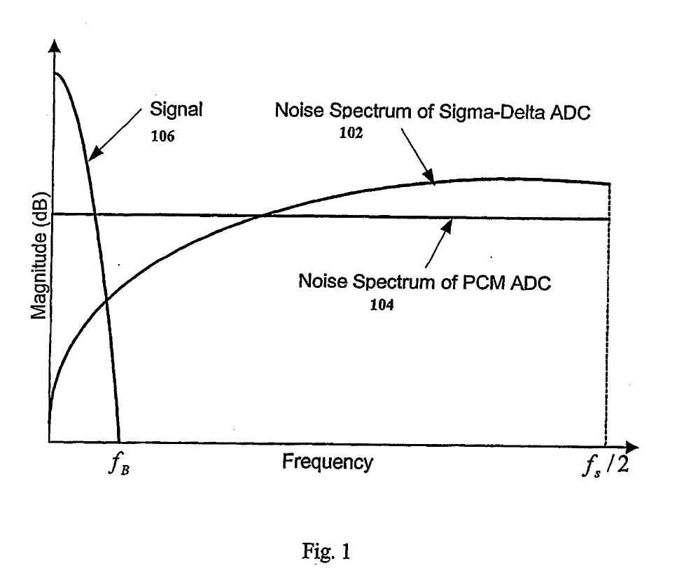

### DETAILED DESCRIPTION

Sigma-Delta CDMA (SD-CDMA) receivers and RAKE receivers according to embodiments of the invention are described hereinafter. Such SD-CDMA receivers have advantages of low complexity, low power consumptions, low over-sampling ratio and high digitisation resolutions.

SD-CDMA Receivers

In CDMA transmissions, the base-band signals are spread to be wide-band and noise-like. The spreading of signal spectrums is achieved using pseudo random signal-spreading codes known as pseudo-noise (PN) sequences. Such codes are independent of or uncorrelated to message bearing signals and are chosen to achieve near-orthogonality between each other. The PN sequences are used to spread, as well as de-spread, the signal spectrums.

During despreading, a conventional CDMA receiver correlates a sampled multi-bit signal received with a single-bit PN sequence. This requires a multi-bit multiplier/adder operating at an over-sampled frequency. By using Sigma-Delta modulation, however, a SD-CDMA receiver in accordance with the embodiments of the invention is able to reduce the complexity of the despreading operation by using a single-bit Sigma-Delta ADC output for despreading, hence enabling the implementation of the despreading with simple logic gates.

By integrating the despreading block into the Sigma-Delta ADC and more specifically, implementing the despreading function between the Sigma-Delta modulator and demodulator in the embodiments of the invention, the oversampling ratio can be kept low. This is because, upon multiplying with the spread sequence, the uncorrelated quantisation noise introduced by the Sigma-Delta modulator into the wideband received signal remains low in power, while the Signal-to-Noise ratio in the data bandwidth is increased by the spreading factor. The inherent noise shaping in the Sigma-Delta modulator enables a high Signal-to-Noise ratio to be achieved at the despread data bandwidth, thus enabling high digitisation resolution to be achieved for wideband CDMA signals by using a SD CDMA receiver in accordance with the embodiments of the invention.

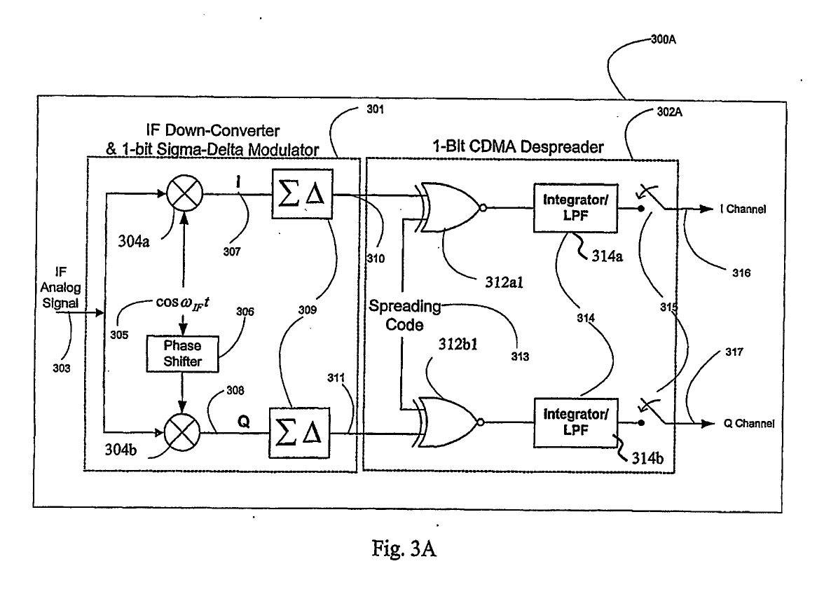

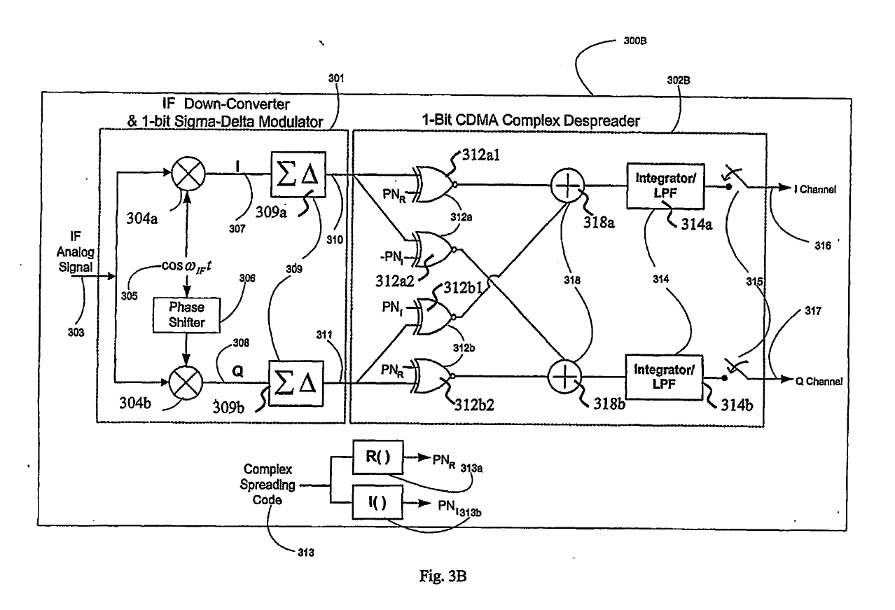

FIG. 3A is a block diagram of a SD-CDMA receiver 300a in accordance with an embodiment of the invention, where the receiver 300a comprises an IF down-converter and 1-bit Sigma-Delta modulator module 301 and a 1-bit CDMA despreader 302A. As shown in FIG. 3A, an input analog signal 303 is separated into I- and Q-signal channels 307 and 308 by mixers 304a and 304b, respectively, in which each mixer 304b uses a carrier which is 900 phase-shifted from the one for mixer 304a. A common carrier generator 305 is used to generate the carriers and a phase-shifter 306 is used to phase-shift one of the carriers.

The separated I and Q signal 307 and 308 are then each digitised and modulated by a respective one of a pair of first-order 1-bit Sigma-Delta modulators 309 operating at over-sampled frequencies. The outputs from the pair of single-bit Sigma-Delta ADCs 309 are hence a pair of over-sampled single-bit data streams 310 and 311 representative of the pair of analog signals 307 and 308 corrupted by quantisation noise, respectively.

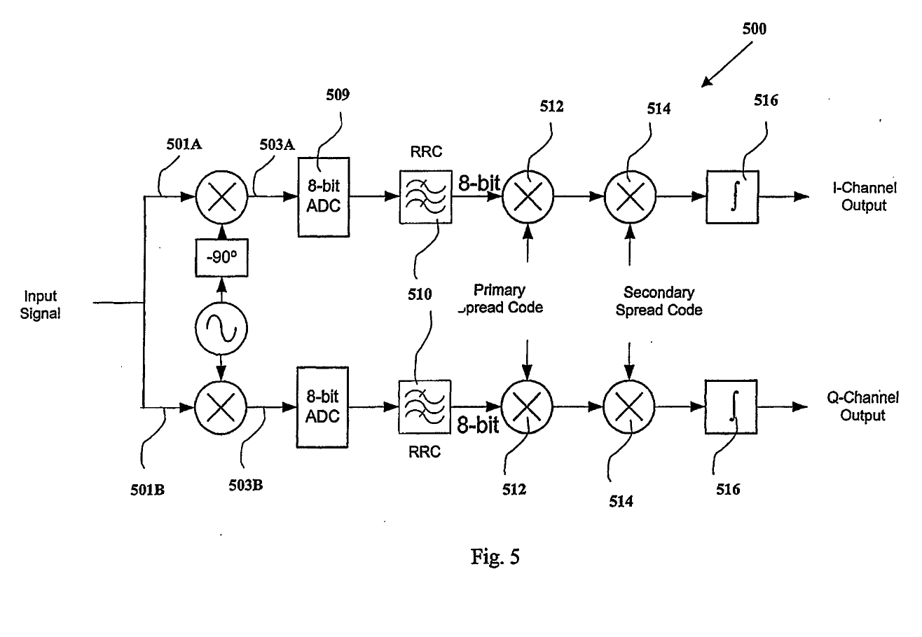

This architecture of the SD-CDMA receiver 300a therefore allows a CDMA despreading process to be performed by the simple use of a pair of dual-input exclusive-NOR gates 312a and 312b in the despreader 302A, as opposed to conventional CDMA receivers that use multi-bit multipliers 512 as shown in FIG. 5. The over-sampled single-bit data stream 310 and 311 are fed to a respective input of dual-input exclusive-NOR gate 312a and 312b, while a spreading code 313 is fed to the other input of each dual-input exclusive-NOR gate 312a and 312b for despreading and channel selection The spreading code 313 may be an orthogonal sequence or a combination of orthogonal sequence and some other scrambling code.

In a further embodiment shown in FIG. 3B, the despreading architecture may be extended to include complex spreading wherein the outputs 310 and 311 from the pair of Sigma-Delta modulators are fed into two pairs of exclusive-NOR gates 312a and 312b. A complex spreading code generator 313 is used to generate a pair of real 313a and imaginary 313b PN sequences (PN_{R} and PN_{I}). The despreading logic gates 312 are not limited to exclusive-NOR gates, but may be replaced by alternative combination of simple logic gates. The outputs of the exclusive-NOR gate 312a1 with PN_{R} as an input and the exclusive-NOR gate 312b1 with PN_{I} as an input are summed by adder 318a. Similarly, the outputs of the exclusive-NOR gate 312a2 with PN_{I} as an input and the exclusive-NOR gate 312b2 with PN_{R} as an input are summed by a second adder 318b.

The outputs of the dual-input exclusive-NOR gates 312a and 312b in FIG. 3A or the output of the adders 318a and 318b in FIG. 3B are fed respectively to the inputs of a pair of integrators 314a and 314b or its equivalent. The integrators 314a and 314b then output a pair of multi-bit samples consisting of I and Q-signals 316 and 317, respectively, at the base-band symbol rate via a pair of downsamplers 315. The pair of integrators 314 and downsamplers 315 effectively serve as a pair of Sigma-Delta demodulators, hence eliminating the need for a further stage of Sigma-Delta demodulation.

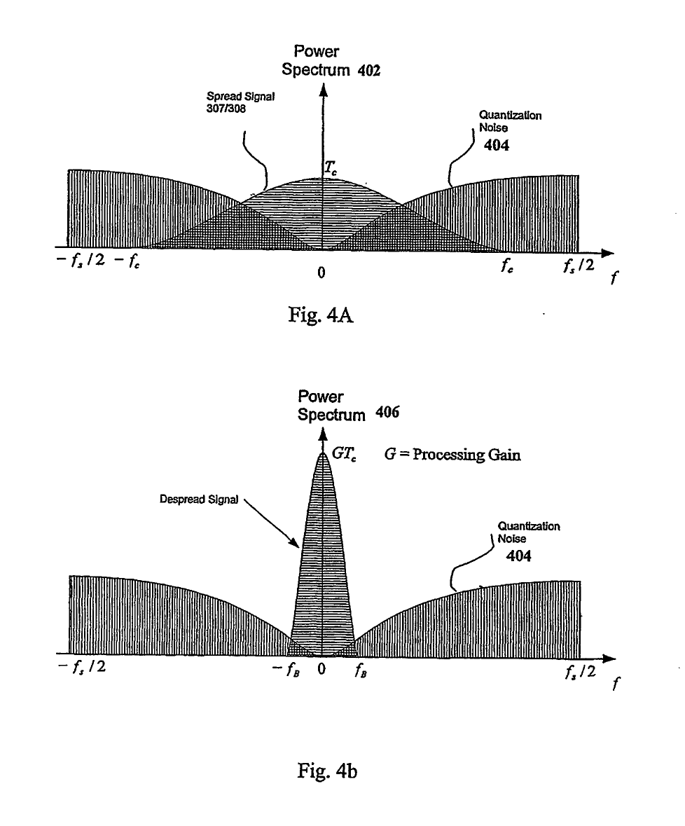

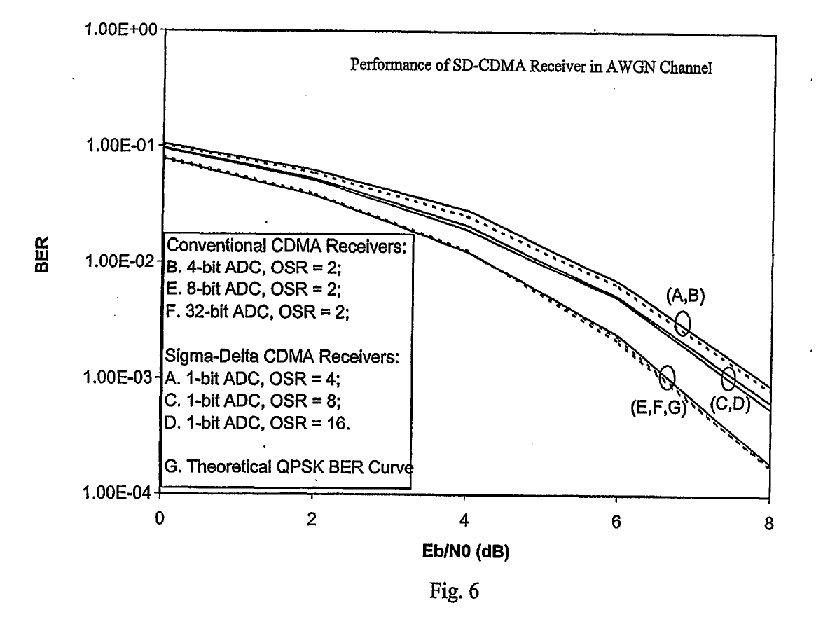

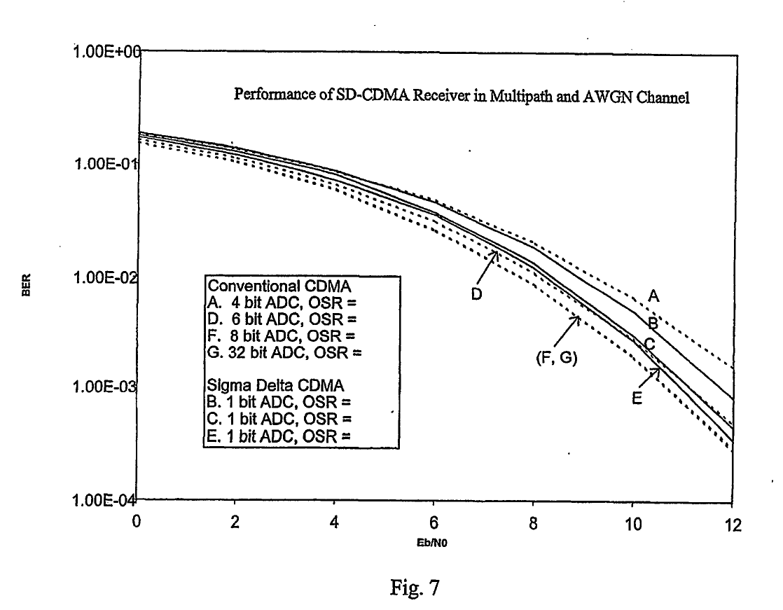

The despreading process employed in the SD-CDMA receiver 300a and 300b is analysed in greater detail with reference to spectral diagrams shown in FIGS. 4A and 4B. An assumption of uniform white quantisation noise is popularly used for analysing analog-to-digital (A/D) conversion processes, which is true only when Bennet's conditions are satisfied. W. R. Bennet, “Spectra of quantized signals”, Bell Syst. Tech. J., vol. 27, pp. 446-472, July 1948, describes these conditions. Though these conditions are not met in many cases, the assumption of uniform white quantisation noise is usually made for simplicity. The validity of the assumption is then typically verified by simulation. This assumption is thus used for the analysis with reference to FIGS. 4a and 4b. The validity of the assumption is then verified by simulations described in greater detail with reference to FIGS. 6 and 7.

FIG. 4A illustrates the power spectrum 402 of each over-sampled single-bit data stream 310 or 311 representative of received wide-band analog signal 307 or 308 at the output of each single-bit Sigma-Delta modulator 309. The power spectrum 402 is corrupted by quantization noise 404 due to the use of a lower over-sampling ratio (OSR=ƒₛ/(2ƒ_{c}) where ƒₛ is the sampling frequency and ƒ_{c} is the spreading chip rate) Sigma-Delta modulator 309 for practical reasons.

As shown in FIG. 4B, the despreading processing following the Sigma-Delta modulator 309 restores a base-band data signal with a bandwidth of ƒ_{b} at the output of each downsampler 315. Based on the assumption of uniform white quantisation noise, no additional quantization noise is therefore introduced by the despreading process into the signal band (−ƒ_{b}≦ƒ≦ƒ_{b}). The power spectrum 406 of the despread base-band data signal together with the same quantization noise spectrum 404 is shown in FIG. 4B. Since most of the quantization noise power lies outside the desired signal band (−ƒ_{b}≦ƒ≦ƒ_{b}), the base-band data signal can be extracted at very high resolution using low-pass filtering with cut-off frequency at ƒ_{b}.

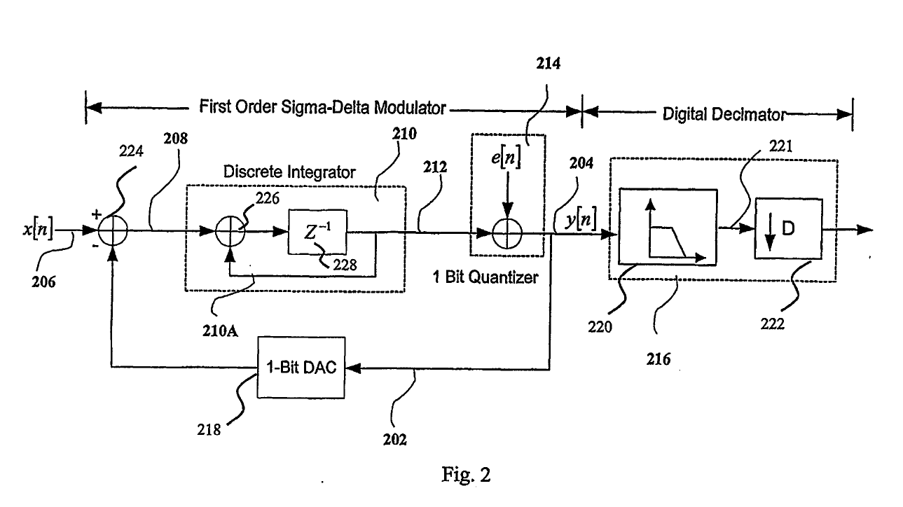

FIG. 5 shows a block diagram of a conventional CDMA receiver 500, which is also separated into I- and Q-channels 503A and 503B, respectively. Compared with such a conventional CDMA receiver 500, the SD-CDMA receiver 300 has a much more efficient and compact architecture. The single-bit Sigma-Delta modulator 309 used in the SD-CDMA receiver 300a and 300b consists of only a single-bit ADC and a feedback loop as shown in FIG. 2, which is less complicated and consumes less power than a conventional multi-bit ADC 509 used in the conventional CDMA receiver 500. A pair of root-raised-cosine (RRC) filters 510 used in the conventional CDMA receiver 500 is not a necessary feature in the SD-CDMA receiver 300 because such a pair of RRCs 510 does not have very significant effects on the system performance of the SD-CDMA receiver 300.

For the despreading process, the conventional CMA receiver 500 uses multi-bit multipliers 512 and 514, respectively. On the other hand, in the SD-CDMA receiver 300, the spreading code 313, and over-sampled data streams 310 and 311 are single-bit data streams. This allows dual-input exclusive-NOR gates 312 alone or with adders 318 to be used to perform the dispreading process. The SD-CDMA receiver 300 therefore has significant advantages over the conventional CDMA receiver 500 in terms of lower complexity and power consumption.

Performances of the SD-CDMA receiver 300 and conventional CDMA receiver 500 are compared hereinafter in greater detail with reference to FIGS. 6 and 7. The performances of both the SD-CDMA receiver 300 and conventional CDMA receiver 500 are compared using results from simulations carried out using Signal Processing Worksystem (SPW) from Cadence Design Systems, Inc. The communication channel models used in the simulations are Additive White Gaussian Noise (AWGN), and multi-path with AWGN channels. For simulations of the conventional CDMA receiver 500, the OSR is fixed at 2 while multi-bit ADC's with different resolutions are used. On the other hand, for simulations of the SD-CDMA receiver 300, only a single-bit ADC is used while the OSR is varied. Simulation results from SPW are shown in FIGS. 6 and 7.

FIG. 6 compares the bit error rate (BER) performances of the SD-CDMA receiver 300 and the conventional CDMA receiver 500 in an AWGN channel. The BER curves E and F relating to the conventional CDMA receiver 500 with eight-bit and 32-bit ADCs almost overlap with the theoretical BER curve G of a quadrature phase-shift keying (QPSK) receiver. The performance of the QPSK receiver provides a lower bound for that of a CDMA receiver and hence used as the reference. The main reason for the overlap is that in the absence of multi-path fading, an 8-bit ADC is sufficient for the conventional CDMA receiver 500 to achieve near to theoretical performance of a QPSK receiver.

The BER curve C relating to the SD-CDMA receiver 300 with the OSR set at 8 achieves a better performance than that of the conventional CDMA receiver 500 with a four-bit ADC corresponding to BER curve B. When the OSR is increased, the BER performance of the SD-CDMA receiver 300 is improved. With the OSR set at 16, the additional E_{b}/N₀ required by the SD-CDMA receiver 300 to achieve the same performance as the conventional CDMA receiver 500 with a 32-bit ADC is less than 1 dB.

Because multi-path is an important characteristic of the wireless communication channel, FIG. 7 compares the BER performances of the SD-CDMA receiver 300 and the conventional CDMA receiver 500 in a multi-path with AWGN channel. The BER curves F and G relating to the conventional CDMA receiver 500 with eight-bit and 32-bit ADCs overlap. This shows that even in a multi-path channel, using an ADC with more than 8 bits in the conventional CDMA receiver 500 does not provide any advantage. As shown in FIG. 7, the performance of the SD-CDMA receiver 300 improves when the OSR is increased as shown in BER curves B, C, and E. At the same BER, the difference of E_{b}/N₀ between the SD-CDMA receiver 300 with the OSR set at 16 and the conventional CDMA receiver 500 with a 32-bit ADC is less than 0.5 dB.

The design concept of the SD-CDMA receiver 300 in accordance with the embodiments of the invention is therefore verified by the simulation results shown in FIGS. 6 and 7. With OSRs set relatively low, the SD-CDMA receiver 300 is able to achieve performances close to the conventional CDMA receiver 500, while providing more hardware and power efficiencies. Further improvement to the performance of the SD-CDMA Receiver may be achieved with the use of higher-order Sigma-Delta ADC and the employment of noise-dithering techniques in the SD-DMA receiver 300. Tradeoffs can thus be made between a lower OSR and higher-order implementation. Similarly, based on different hardware efficiency and dynamic-range requirement, various configurations of the proposed Sigma-Delta CDMA Receiver can be employed. Examples of which include using multi-bit ADC/DAC as opposed to the aforementioned single-bit ADC/DAC, multi-stage as opposed to single-stage, higher order, and band-pass Sigma-Delta modulators.

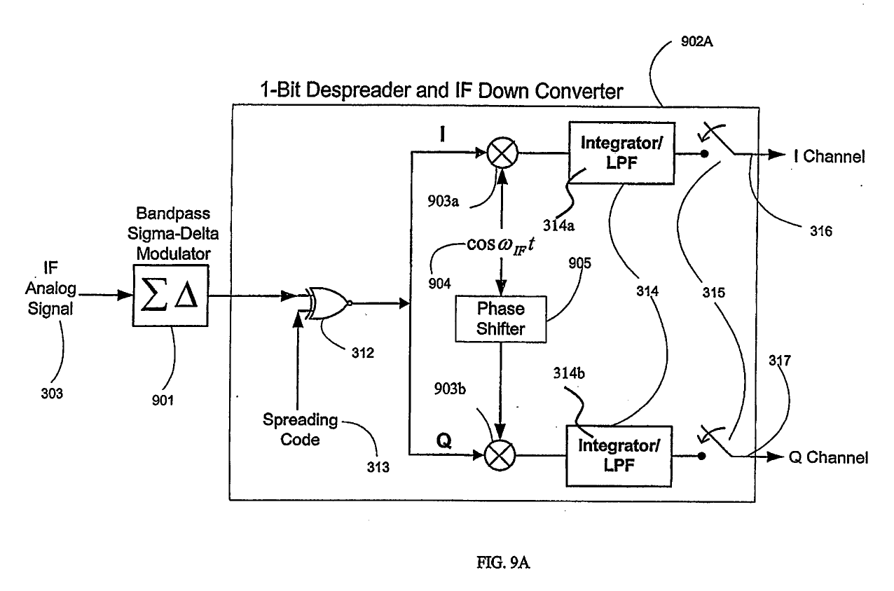

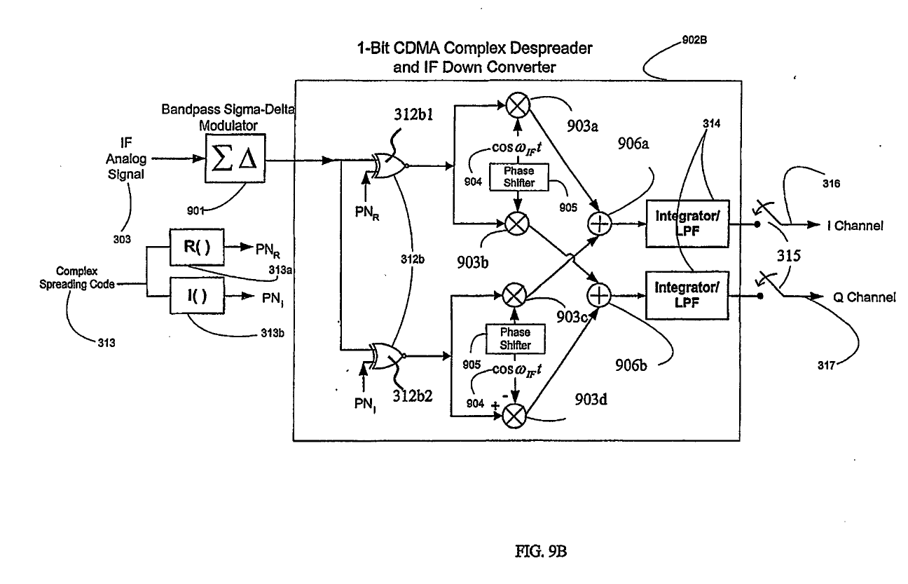

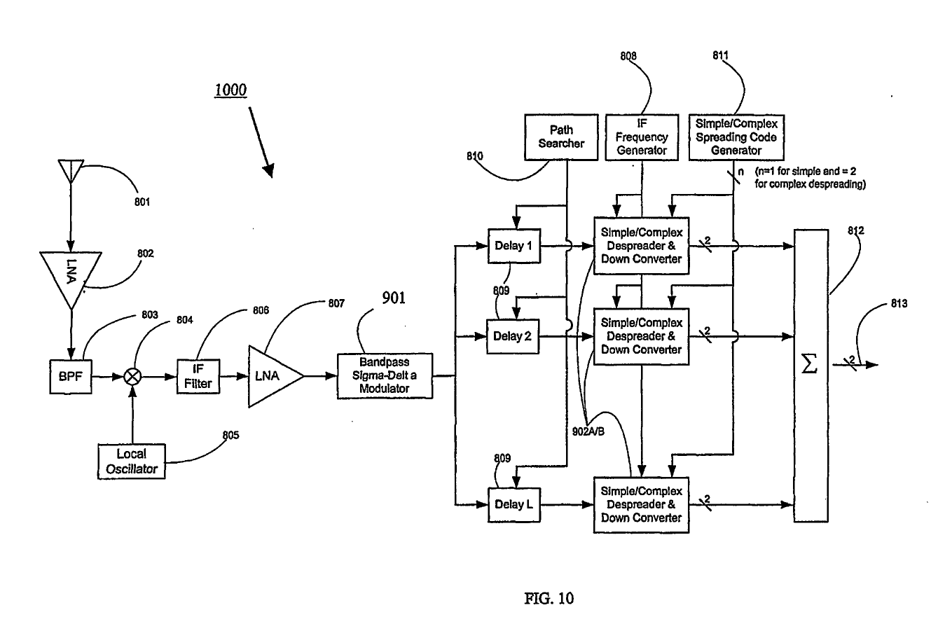

In particular, the last variation, band-pass Sigma-Delta configuration is of great interest to those familiar in the art. Such configurations are shown in FIGS. 9A and 9B. The block diagrams are similar to those described with reference to FIGS. 3A and 3B.

With reference to FIG. 9A, an analogue IF signal 303 is input to a bandpass Sigma-Delta modulator 901. The output of the Sigma-Delta modulator 901 is provided to the 1-bit despreader and IF down converter 902a, and in particular is provided to an exclusive NOR gate 312. The other input of the exclusive NOR gate 312 is the spreading code 313. The output of the exclusive NOR gate 312 is fed to mixers 903a and 903b, respectively. The I component is mixed with carrier 904, and the Q component is mixed with a phase shifted carrier (by phase shifter 905). The output of the two mixers 903a and 903b are provided to respective integrator/low pass filter modules 314a and 314b. The outputs of the integrators/low pass filters 314a and 314b are provided to respective downsamplers 315 to produce the I channel 316 and the Q channel 317.

With reference to a further embodiment shown in FIG. 9B, the analogue IF signal 303 is again provided to the bandpass Sigma-Delta modulator 901 before being provided to the 1-bit CDMA complex despreader and IF down converter 902b. The output of the Sigma-Delta modulator 901 is provided to one input of two exclusive NOR gates 312b, forming a pair. The other input of the exclusive NOR gate 312b I is provided with the real part of the complex spreading code PN_{R}. The other exclusive NOR gate 312b2 has the imaginary part of a complex spreading code PN_{I} applied to its remaining input. The output of the exclusive-NOR gate 312b1 is provided to a pair of mixers 903a and 903b. The output of the other exclusive-NOR gate 312b2 is provided to another pair of mixers 903c and 903d. The mixers 903a and 903d mix a carrier 904 directly and the other mixers 903b and 903d mix a phase shifted carrier (produced by phase shifter 905). The outputs of mixers 903a and 903c are provided to an adder 906a. The outputs of mixers 903b and 903d are provided to a second adder 903c. In turn the outputs of adders 906a and 906b are provided to respective integrators/low pass filters 314. The outputs of integrators/low pass filters 314 are provided to respective downsamplers 315 to produce I channel 316 and Q channel 317 baseband signal.

The key changes of the foregoing embodiments include the use of a bandpass Sigma-Delta modulator 901 in FIGS. 9A and 9B in place of a baseband Sigma-Delta modulator 309 in FIGS. 3A and 3B, and the use of a digital IF oscillator 904 as opposed to an analogue IF oscillator 305. The bandpass Sigma-Delta modulator 309 converts the analogue IF signal 303 into single-bit data stream representative of the original input signal added with quantisation noise. Despreading is similarly performed with simple exclusive-NOR gate 312. The 1-bit resultant signal is then separated into I and Q channels by digitally mixing with an oversampled sinusoidal carrier 904 at the IF frequency. The integrators 314 perform Sigma-Delta demodulation and remove the out-of-band quantisation noise.

RAKE Receivers

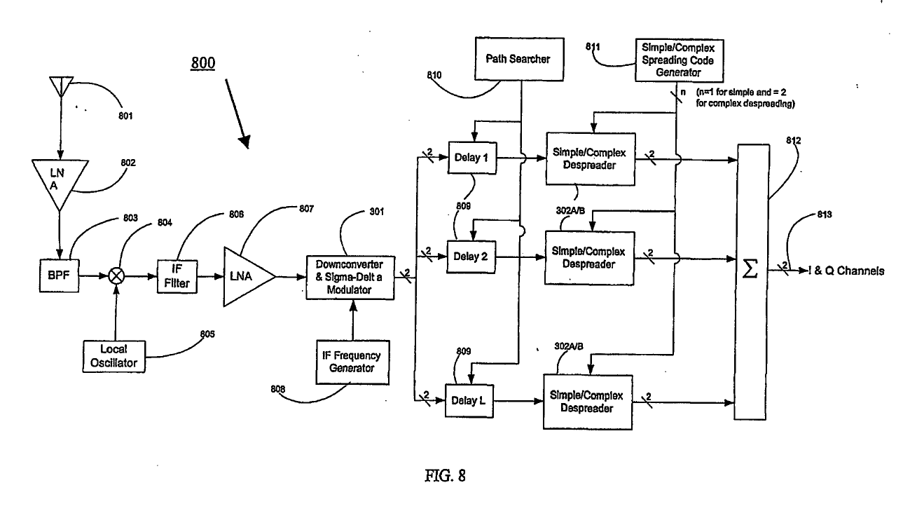

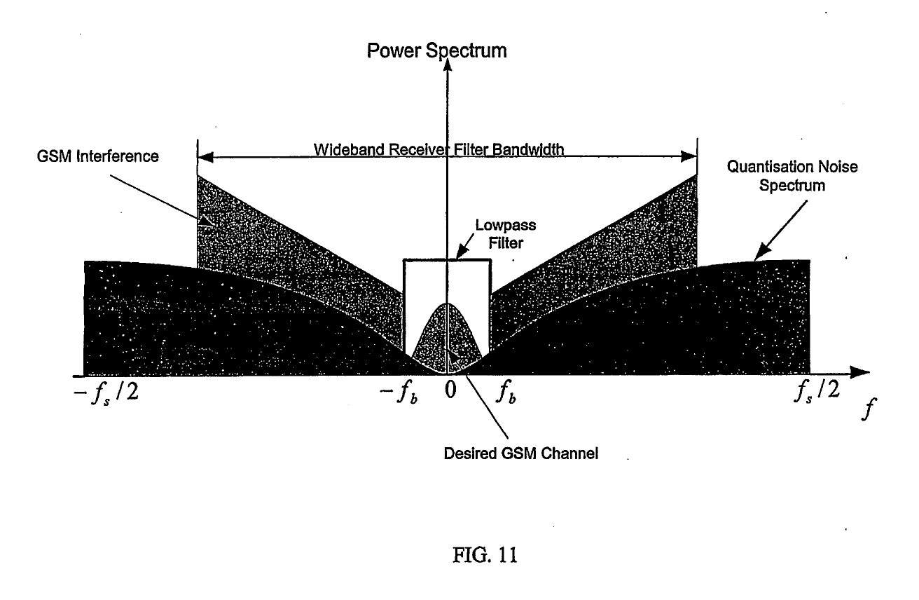

The embodiments of the invention described with reference to FIGS. 3A and 3B and FIGS. 9A and 9B have application in RAKE receivers. In particular, FIG. 8 is a block diagram of a RAKE receiver 800 utilising either of the baseband SD-CDMA receivers in accordance with the embodiment shown in FIGS. 3A and 3B. FIG. 10 illustrates another RAKE receiver 1000 utilising either of the bandpass SD-CDMA receivers in accordance with the embodiments of FIGS. 9A and 9B.

With reference to FIG. 8, the RAKE receiver 800 includes an antenna 801 coupled to a linear amplifier 802. The output of the linear amplifier 802 is filtered by a bandpass filter 803. The bandpass filtered output signal from filter 803 is mixed with a carrier from a local oscillator 805 using a mixer 804. The mixer output is provided to an IF filter 806 before being input to a linear amplifier 807. The output of the linear amplifier 807 is then input to a down converter and a Sigma-Delta modulator 301 in accordance with the embodiments of FIGS. 3A and 3B. An IF frequency generator 808 is coupled to the down converter and modulator 301. The I and Q channel outputs of the down converter modulator 301 are then provided as input to delay elements 1, 2, . . . , L 809. A path searcher module 810 detects the strongest power received multipaths and their corresponding path delays. The path delays are input to the delay modules 809 to align the received symbols with the locally generated spreading code.

The outputs of the respective delay elements 809 are coupled to corresponding despreaders. In particular, the despreader utilized can be either a simple despreader 302a of FIG. 3A or a complex despreader 302b of FIG. 3B. Either a simple or a complex spreading code generator 811 is coupled to each of the despreaders 302a/b. The generator 811 has N bits where N equals 1 for simple spreading code generation and 2 for complex despreading. The two outputs of each despreader 302a/b are input to a linear combiner module 812, which combines all complex outputs of each despreader 302a and 302b to provide a complex baseband signal 813 at its output with higher Signal-to-Noise Ratio (SNR). The foregoing provides an implementation of a RAKE receiver using either of the embodiments of FIGS. 3A and 3B.

A further RAKE receiver 1000 is shown in FIG. 10. Elements corresponding with like elements in FIG. 8 have corresponding numbers in FIG. 10. The description of like elements in FIG. 10 is not repeated in view of the description of FIG. 8 so as to avoid being repetitious. The configuration of elements 801-807 in FIGS. 8 and 10 are the same. The output of linear amplifier 807 in FIG. 10 is provided as input to a bandpass Sigma-Delta modulator 901 of FIG. 10.

The output of the bandpass Sigma-Delta modulator 901 is coupled to L delay modules 809. A path searcher module 810 is also coupled to each delay module 809, as described with reference to FIG. 8. The outputs of the respective delay modules 809 are input to a corresponding despreader and down converter 902a of FIG. 9A or 902b of FIG. 9B. That is, the module can be a simple or a complex depsreader and down converter. An IF frequency generator 808 provides an input to each of the despreader and down converter modules 902A/B. Again, the spreading code generator 811 of FIG. 8 is coupled to each of the despreader and down converter modules 902A/B. The output of each despreader and down converter module 902A/B is also coupled to a summer 812 which provides I and Q channels 813. Thus, yet another embodiment of the RAKE receiver is disclosed.

As a further application, the invention is highly suited for Software Radio type of receivers. A predominant feature of a Software Radio receiver is a wideband ADC with high dynamic range. PCM ADC with high dynamic range is difficult to implement and is high in power thus rendering them impractical. A conventional Sigma-Delta ADC is also not a good choice as its application is limited to narrowband signals for reasons discussed earlier. As such, the above described SD-CDMA receiver, which is capable of digitising a Wideband Signal at low oversampling ratio is a good choice as it is low in complexity and low in power.

An example of such a system would be a dual-mode W-CDMA and GSM receiver station. Despreading of the W-CDMA signal has been described and proven earlier; high dynamic range can also be achieved for the narrowband GSM signal by suitable noise shaping using the same SD-CDMA modulator as illustrated in FIG. 11. As a further addition, a bandpass SD-CDMA modulator may be used for GSM channel selection. As shown in FIG. 11, the desired GSM channel together with a large amount of interference is received by the wideband receiver. After Sigma-Delta modulation, most of the quantisation noise lies outside the desired channel bandwidth because of the inherent noise-shaping nature performed by the Sigma-Delta modulator. By lowpass filtering the modulated signal, the interference, together with the out-of-band quantisation noise is attenuated and the digitised GSM signal can be restored with high-resolution.

In the foregoing manner, Sigma-Delta modulation CDMA receivers and RAKE receivers are described according to embodiments of the invention for improving the conventional CDMA receiver. Although only a number of embodiments are disclosed, it will be apparent to one skilled in the art in view of this disclosure that numerous changes and/or modifications can be made without departing from the scope and spirit of the invention.

We claim:

1. A method of code division multiple-access reception, said method including the steps of:
digitising an analog quadrature spread signal, with which a spreading code is associated, using a pair of Sigma-Delta modulators to form a digital quadrature spread signal; and
correlating said digital quadrature spread signal to provide a despread baseband signal, said correlating step including the steps of:
delaying said digital quadrature spread signal with a pre-selected delay value in terms of number of digital samples; and
despreading said delayed digital quadrature spread signal with said associated spreading code to form said despread baseband signal at a symbol rate.

2. The method according to claim 1, wherein the Sigma-Delta modulators are single-bit Sigma-Delta modulators.

3. The method according to claim 1, wherein the Sigma-Delta modulators are at least a first order Sigma-Delta modulator.

4. The method according to claim 1, wherein the despreading step is carried out using single-bit logic gates.

5. The method according to claim 4, wherein said single-bit logic gates include at least dual-input exclusive-NOR gates.

6. The method according to claim 1, wherein said despreading step involves complex despreading and said associated spreading code is a complex spreading code.

7. The method according to claim 1, wherein said delaying step is carried out using a delay element.

8. A code division multiple-access receiver, including:
a pair of Sigma-Delta modulators for digitising an analog quadrature spread signal, with which a spreading code is associated, to form a digital quadrature spread signal; and
at least one correlator, each including:
a delay element for delaying said digital quadrature spread signal with a pre-selected delay value in terms of number of digital samples; and
a despreader for despreading said delayed digital quadrature spread signal with said associated spreading code to form a despread baseband signal at a symbol rate.

9. The receiver according to claim 8, wherein the Sigma-Delta modulators are single-bit Sigma-Delta modulators.

10. The receiver according to claim 8, wherein the Sigma-Delta modulators are at least a first order Sigma-Delta modulator.

11. The receiver according to claim 8, wherein the despreader includes single-bit logic gates.

12. The receiver according to claim 11, wherein said single-bit logic gates include at least dual-input exclusive-NOR gates.

13. The receiver according to claim 8, wherein said despreader is a complex despreader and said associated spreading code is a complex spreading code.

14. A method of code division multiple-access reception, said method including the steps of:
digitising an analog bandpass spread signal, with which a spreading code is associated, using a bandpass Sigma-Delta modulator to form digital bandpass spread signal; and
correlating said digital quadrature spread signal to provide a despread baseband signal, said correlating step including the steps of
delaying said digital bandpass spread signal with a pre-selected delay value in terms of number of digital samples;
multiplying said delayed digital bandpass spread signal with said associated spreading code to form a bandpass product signal;.
digitally mixing down said bandpass product signal; and
filtering said mixed-down bandpass product signal to form said despread baseband signal at symbol rate.

15. The method according to claim 14, wherein the bandpass Sigma-Delta modulator is a single-bit bandpass Sigma-Delta modulator.

16. The method according to claim 14, wherein the bandpass Sigma-Delta modulator is at least a first order bandpass Sigma-Delta modulator.

17. The method according to claim 14, wherein the multiplying step is carried out using single-bit logic gates.

18. The method according to claim 14, wherein said associated spreading code is a complex spreading code and said multiplying step involves complex multiplication.

19. The method according to claim 18, wherein said single-bit logic gates includes at least two dual-input exclusive-NOR gates.

20. The method according to claim 14, wherein said filter step is carried out using a low-pass filter or an integrator.

21. A code division multiple-access receiver, including:
a bandpass Sigma-Delta modulator for digitising an analog bandpass spread signal, with which a spreading code is associated, to form digital bandpass spread signal; and
at least one correlator, each including:
a delay element for delaying said digital bandpass spread signal with a pre-selected delay value in terms of number of digital samples;
a multiplier for multiplying said delayed digital bandpass spread signal with said associated spreading code to form a bandpass product signal;
a digital mixer for mixing down said bandpass product signal; and
a filter for filtering said mixed-down bandpass product signal to form a despread baseband signal at symbol rate.

22. The receiver according to claim 21, wherein the bandpass Sigma-Delta modulator is a single-bit bandpass Sigma-Delta modulator.

23. The receiver according to claim 21, wherein the bandpass Sigma-Delta modulator is at least a first order bandpass Sigma-Delta modulator.

24. The receiver according to claim 21, wherein the multiplier comprises single-bit logic gates.

25. The receiver according to claim 21, wherein said associated spreading code is a complex spreading code and the multiplier is a complex multiplier.

26. The receiver according to claim 25, wherein said single-bit logic gates includes at least two dual-input exclusive-NOR gates.

27. The receiver according to claim 21, wherein the filter is a low-pass filter or an integrator.
